(19) United States
(12) Patent Application Publication
(10) Pub. No.: US 2026/0316286 A1
(43) Pub. Date: Oct. 15, 2026

(54) ROBOT CONTROL SYSTEM, INFERENCE SYSTEM, AND ROBOT CONTROL METHOD

(71) Applicant: KABUSHIKI KAISHA YASKAWA DENKI, Kitakyushu-shi (JP)

(72) Inventors: Keita SATSUMA, Kitakyushu-shi (JP); Hiroki TACHIKAKE, Kitakyushu-shi (JP); Hisashi IDEGUCHI, Kitakyushu-shi (JP)

(73) Assignee: KABUSHIKI KAISHA YASKAWA DENKI, Kitakyushu-shi (JP)

(21) Appl. No.: 19/461,730

(22) Filed: Jan. 28, 2026

(30) Foreign Application Priority Data
Jan. 31, 2025 (JP) 2025-015436
Jun. 13, 2025 (JP) 2025-099365

(51) Int. Cl. B25J 9/16; B65G 61/00; G06T 7/11; G06T 7/50; G06V 10/25; G06V 10/26; G06V 10/774; G06V 20/50

(52) U.S. Cl. CPC B25J 9/1697; B65G 61/00; G06T 7/11; G06T 7/50; G06V 10/25; G06V 10/267; G06V 10/774; G06V 20/50; G06T 2207/20081; G06T 2207/20212

(57) ABSTRACT

A robot control system includes a converter configured to convert depth information with respect to a target region including one or more workpieces into a depth map represented by channel information corresponding to one or more channels of an image that does not include the depth information; an image synthesizer configured to synthesize the depth map with a reference image capturing the target region to generate a synthesized image; inference circuitry configured to input the synthesized image to a learned model that has learned to execute an inference by receiving the image that does not include the depth information so that the inference circuitry executes the inference on the one or more workpieces; and robot control circuitry configured to control a robot to execute processing related to the one or more workpieces based on a result of the inference for the one or more workpieces.

### CROSS-REFERENCE TO RELATED APPLICATIONS

The present application claims priority under 35 U.S.C. § 119 to Japanese Patent Application No. 2025-015436, filed Jan. 31, 2025 and Japanese Patent Application No. 2025-099365, filed Jun. 13, 2025. The contents of these applications are incorporated herein by reference in their entirety.

### BACKGROUND

### Technical Field

One aspect of the present disclosure relates to a robot control system, an inference system, and a robot control method.

### Background Art

Techniques for causing a robot to process a workpiece based on an image capturing the workpiece are known. For example, Japanese Unexamined Patent Application Publication No. 2023-113572 describes a robotic system that identifies incorrectly depicted objects within an image of a group of objects. This system is used by a robot to identify which object to pick up. The system comprises a 3D camera providing a 2D red-green-blue (RGB) color image and a 2D depth map image of a box, means for processing the RGB image and the depth map image of the box to generate a processed image of the object, means for transmitting the processed image to a user interface if the object cannot be accurately depicted in the processed image, means for training the processing of the RGB image and the depth map image using a correct processed image, a bad processed image, and a modified processed image, and means for applying the trained processed image to a new RGB and depth map image.

### SUMMARY

According to one aspect of the present disclosure, a robot control system includes a converter configured to convert depth information with respect to a target region including one or more workpieces into a depth map represented by channel information corresponding to one or more channels of an image that does not include the depth information; an image synthesizer configured to synthesize the depth map with a reference image capturing the target region to generate a synthesized image; inference circuitry configured to input the synthesized image to a learned model that has learned to execute a predetermined inference by receiving the image that does not include the depth information so that the inference circuitry executes the predetermined inference on the one or more workpieces; and robot control circuitry configured to control a robot that exists in a real work space to execute processing related to the one or more workpieces based on a result of the predetermined inference for the one or more workpieces.

According to another aspect of the present disclosure, an inference system includes a converter configured to convert depth information with respect to a target region including one or more workpieces into a depth map represented by channel information corresponding to one or more channels of an image that does not include the depth information; an image synthesizer configured to synthesize the depth map with a reference image capturing the target region to generate a synthesized image; and inference circuitry configured to input the synthesized image to a learned model that has learned to execute a predetermined inference by receiving the image that does not include the depth information so that the inference circuitry executes the predetermined inference on the one or more workpieces.

According to further aspect of the present disclosure, a robot control method is executed by a robot control system including at least one processor. The robot control method includes converting depth information with respect to a target region including one or more workpieces into a depth map represented by channel information corresponding to one or more channels of an image that does not include the depth information; synthesizing the depth map with a reference image that captures the target region to generate a synthesized image; inputting the synthesized image to a learned model that has learned to execute a predetermined inference by receiving the image that does not include the depth information so as to execute the predetermined inference on the one or more workpieces; and controlling a robot that exists in a real work space to execute processing related to the one or more workpieces based on a result of the predetermined inference for the one or more workpieces.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a diagram illustrating an example of application of a robot control system.

FIG. 2 is a diagram illustrating an example of a hardware configuration of a robot controller.

FIG. 3 is a flowchart illustrating an example of processing for generating a trained model.

FIG. 4 is a flowchart illustrating an example of robot control based on inference using the trained model.

FIG. 5 is a diagram illustrating an example of generation of a synthesized image.

### DESCRIPTION OF THE EMBODIMENTS

Hereinafter, various examples in the present disclosure will be described in detail with reference to the accompanying drawings. In the description of the drawings, the same or equivalent elements are denoted by the same reference numerals, and redundant description will be omitted.

### System Overview

The robot control system according to the present disclosure is a computer system that causes a robot to process a workpiece based on an image capturing the workpiece. The robot control system controls the robot based on a reference image, which is an image capturing a target region including one or more workpieces with one or more channels, and depth information indicating a depth that is a distance from a camera to a subject in the target region. The target region can also be said to be a shooting range of the camera. The robot control system converts the depth information into a depth map represented by channel information corresponding to one or more channels of the image that do not include the depth information (i.e., one or more channels of the reference image). In the present disclosure, an image not including depth information refers to an image not having depth information as an independent parameter. The robot control system composites the depth map with the reference image to generate a synthesized image. The robot control system inputs the synthesized image to a learned model that has been learned to receive an input of an image not including depth information and execute predetermined inference, and executes the predetermined inference on the workpiece reflected in the reference image. Then, the robot control system causes the robot to execute processing related to the workpiece based on the inference result.

In the present disclosure, an image (image data) may be a photograph (photograph data) or a frame image (frame image data) constituting a video (video data).

The channel is an element for representing color information of an image. For example, an RGB color image (RGB image) is represented by three channels of R, G, and B, and a grayscale image is represented by one channel. If the reference image is a color image, the depth information may be converted into channel information corresponding to three channels, and thus, the depth map may be expressed as a color image. If the reference image is a grayscale image, the depth information is converted into channel information corresponding to one channel, and as a result, the depth map is represented as a grayscale image. In any case, the depth map does not have depth information as an independent parameter, but indicates channel information indicating a distribution of depths by one or more channels. That is, the depth map indicates the depth distribution by color.

There is a case where a plurality of workpieces that are imaged in an image so as to overlap each other are not accurately inferred only from a general image in which a subject range is expressed only by channel information. For example, when the color tones of the upper workpiece and the lower workpiece stacked on the pallet are similar, a part of one workpiece may be inferred as a part of the other workpiece. If the workpiece is incorrectly inferred, the robot may fail to process the workpiece. By three dimensionally representing the position of each workpiece using the depth information, it is possible to accurately infer the workpiece and cause the robot to accurately process the workpiece.

The depth information is not reflected in the synthesized image as it is, but is converted into a depth map represented by channel information corresponding to one or more channels of an image not including the depth information and then reflected in the synthesized image. That is, the depth information is converted into information (channel information) of the same level as that of the reference image and then reflected on the reference image. Therefore, it is possible to control the robot by using a general learned model that executes inference based on the channel information of the image without preparing a learned model that refers to the depth information as an independent parameter.

### System Configuration

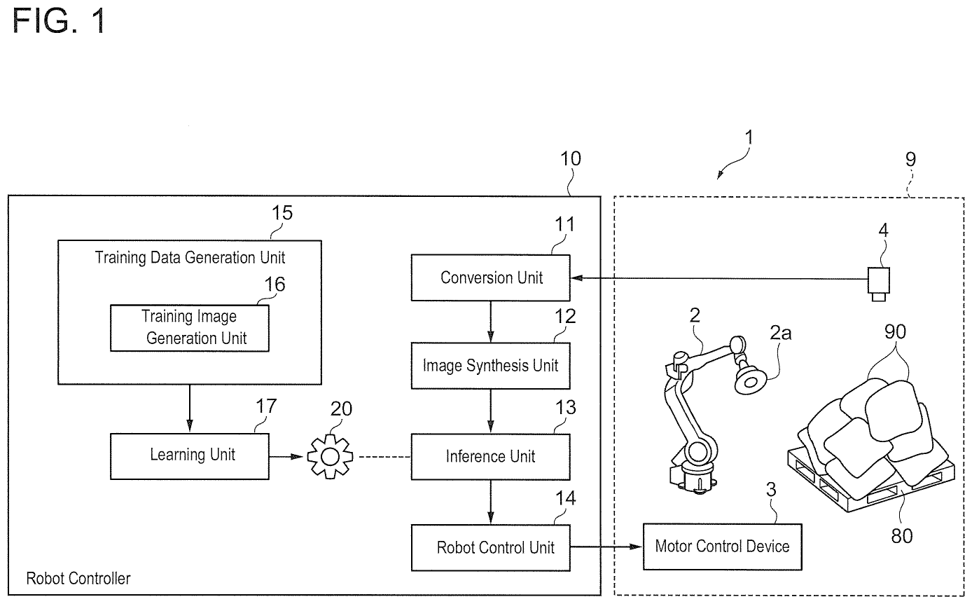

FIG. 1 is a diagram illustrating an example of application of a robot control system. The robot system 1 includes a robot 2 disposed in a real work space 9, a motor control device 3 that controls a motor of the robot 2, and a robot controller 10 that outputs a control signal to the motor control device 3. In this example, the robot control system according to the present disclosure is applied to a robot controller 10. A pallet 80 is provided in the work space 9, and a plurality of workpieces 90 are stacked on the pallet 80. The work space 9 is further provided with a camera system 4 that captures an image of a region including the pallet 80 from above. The robot controller 10 is connected to each of the motor control device 3 and the camera system 4 via a communication network. The communication network connecting the apparatuses may be a wired network or a wireless network. The communication network may include at least one of the Internet and an intranet. Alternatively, the communication network may be simply realized by a single communication cable.

The robot controller 10 uses the learned model 20. The learned model 20 is a calculation model generated by machine learning, which is a method of autonomously finding a law or rule by iteratively learning based on given information. The learned model 20 in this example executes, as the predetermined inference, image segmentation that is processing of identifying the workpiece 90 from an image. The robot system 1 inputs the synthesized image to the learned model 20 to generate an instance for each of the one or more workpieces 90. The instance refers to information indicating a specific object shown in an image in a manner distinguished from other objects in the image. The instances that are the result of the image segmentation are examples of the result of the predetermined inference. The robot system 1 executes processing of taking out at least one of the one or more workpieces 90 from the pallet 80 based on the instance of each of the one or more workpieces 90. The picking up of at least one workpiece 90 is an example of a process related to one or more workpieces 90.

The robot 2 is a device that receives power and performs a predetermined operation according to a purpose to execute useful work. In the robot system 1, the robot 2 executes a process of picking up the workpiece 90 from the pallet 80, that is, a picking process. In one example, the robot 2 includes an arm having a plurality of joints and an end effector 2a attached to the distal end of the arm. The joint is an example of a driving target. A joint axis is set for each of the plurality of joints. Some components of the robot 2 such as the arm and the turning unit rotate about the joint axis. As a result, the robot 2 can freely change the position and the posture of the end effector 2a within a predetermined range. In one example, the robot 2 is a multi-axis serial link type vertical articulated robot. The robot 2 may be a six-axis vertical articulated robot or a seven-axis vertical articulated robot in which one redundant axis is added to six axes. Alternatively, the robot 2 may be a parallel link robot that operates by a mechanism called a parallel link. The robot 2 may be a mobile robot capable of self-traveling, and may be, for example, a robot supported by an automated guided vehicle (AGV). Alternatively, the robot 2 may be a stationary robot fixed at a predetermined place. Examples of end effector 2a for picking operations include grippers and suction ends.

The motor of the robot 2 is a device that generates power for driving a drive target of the robot 2 according to the electric power supplied from the motor control device 3. The individual motors operate the individual drive targets, and as a result, the robot 2 executes a predetermined task on the workpiece 90 using the end effector 2a. The motor may be a rotary motor that rotates a drive target, or may be a linear motor that displaces a drive target along a straight line. The motor may be a synchronous motor or an induction motor. The motor may be a permanent magnet type synchronous motor such as a surface permanent magnet (SPM) motor or an interior permanent magnet (IPM) motor. The motor may be a synchronous motor without permanent magnets, such as a synchronous reluctance motor. The motor may be a DC motor or an AC motor.

The robot 2 may include at least one sensor that is a device that detects a response of the robot 2 that operates by the power from the motor control device 3. The response refers to an output of the robot with respect to a command that is an instruction for controlling the robot. For example, the response indicates information related to at least one of the operation and the state of the robot 2. The response may be indicative of information about the operation and/or status of the motor, for example, indicative of the shaft speed and/or pole position of the motor. In a case where the motor is a rotary type, a rotation angle of a drive target by the motor corresponds to the “position”, and a rotation speed of the drive target by the motor corresponds to the “speed”. The response may indicate information on at least one of the operation and the state of the drive target, and may indicate, for example, at least one of the position, the speed, and the force of the drive target. The sensor transmits a response signal indicating the response to the robot controller 10. The response may be a value itself obtained by the sensor, or may be represented by a value calculated or processed by a given operation or algorithm. An example of the sensor is a rotary encoder that outputs a pulse signal having a frequency proportional to the operating speed of the motor. The rotary encoder can obtain both the position and the speed of the motor.

The motor control device 3 is a device for causing the output of the motor to follow a control signal (that is, a command) from the robot controller 10. The motor control device 3 generates electric power for driving the motor based on a control signal from the robot controller 10, and supplies the electric power to the motor. The supplied electric power corresponds to a driving force command such as a torque command or a current command. The motor control device 3 may be, for example, an inverter or a servo amplifier. The motor control device 3 may be incorporated in the robot 2. The motor control device 3 may include a sensor that detects a response of the motor control device 3.

The camera system 4 is a device that captures an image of a target region including one or more workpieces 90 on the pallet 80 from above. The camera system 4 captures an image of an area including the pallet 80 and transmits image data to the robot controller 10. The image data includes a reference image and depth information. The reference image images the target region. The depth information indicates a distribution of depths in the target region. The camera system 4 may include a first camera that generates a reference image and a second camera that generates a depth image representing depth information. The first camera may be a color camera (e.g., an RGB camera) or a monochrome camera. The second camera is a depth camera. Alternatively, the camera system 4 may be constituted by a single camera that generates an image including both channel information and depth information, and may be realized by, for example, an RGB-D camera. In the present disclosure, a pixel constituting an image having depth information is also referred to as a “depth pixel”. Each pixel of the depth image and each pixel of the RGB-D image are both examples of the depth pixel. The depth information indicates a depth at each depth pixel.

In one example, the target region imaged by the camera system 4 includes a region in which a plurality of workpieces 90 are stacked on the pallet 80. In the reference image, two or more workpieces 90 among the plurality of workpieces 90 are shown in an overlapping manner, and the depth information indicates a distribution of depths in that situation. The depth direction indicated by the depth information is a direction in which the plurality of workpieces 90 are stacked.

Although FIG. 1 shows one robot 2 and one robot controller 10, the robot system 1 may include a plurality of robots 2 or a plurality of robot controllers 10. One robot controller 10 may be connected to a plurality of robots 2. There may be a plurality of pallets 80 and a plurality of camera systems 4.

The robot controller 10 is a device that generates a command for operating the robot 2 and outputs a control signal based on the command. The robot controller 10 is an example of a robot control system as described above, and is also an example of an inference system that executes predetermined inference on one or more workpieces 90 shown in an image. In one example, the robot controller 10 includes, as functional modules, a conversion unit (an example of a “converter”) 11, an image synthesis unit (an example of an “image synthesizer”) 12, an inference unit (an example of “inference circuitry”) 13, a robot control unit (an example of “robot control circuitry”) 14, a training data generation unit 15, a training image generation unit (an example of a “training image generator”) 16, and a learning unit (an example of “learning circuitry”) 17.

The conversion unit 11 is a functional module that receives image data from the camera system 4 and converts depth information included in the image data into a depth map. The image synthesis unit 12 is a functional module that combines a depth map with a reference image included in image data to generate a synthesized image. The inference unit 13 is a functional module that inputs the synthesized image to the learned model 20 that has been learned to receive an input of an image and execute image segmentation, and generates an instance for each of one or more workpieces 90. The robot control unit 14 is a functional module that causes the robot 2 present in the work space 9 to execute processing of taking out at least one of the one or more workpieces 90 from the pallet 80 based on the instance of each of the one or more workpieces 90. Typically, the inference unit 13 generates an instance for each of the plurality of workpieces 90, and the robot control unit 14 causes the robot 2 to execute a process of taking out at least one of the plurality of workpieces 90 from the pallet 80. The training data generation unit 15 is a functional module that generates training data used for generating the learned model 20. The training image generation unit 16 is a functional module that generates a training image constituting the training data. The training image generation unit 16 functions as a part of the training data generation unit 15. The learning unit 17 is a functional module that executes machine learning using training data to generate the learned model 20.

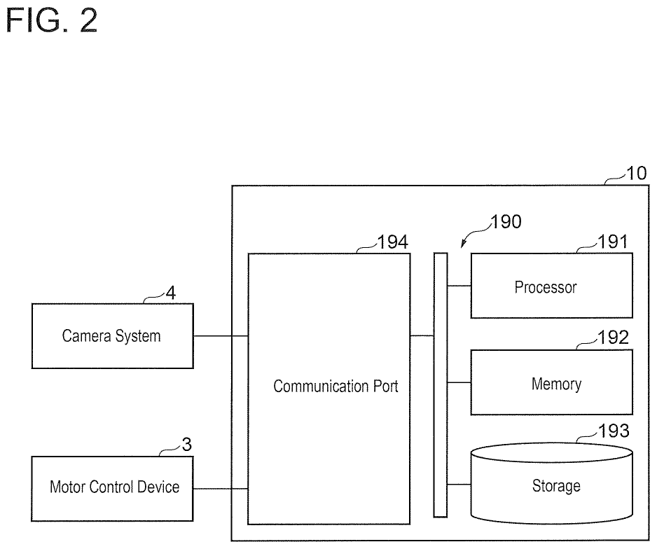

FIG. 2 is a diagram illustrating an example of a hardware configuration of the robot controller 10. The robot controller 10 includes a circuitry 190. In one example, the circuitry 190 includes at least one processor 191, a memory 192, a storage 193, and at least one communication port 194. The storage 193 is a nonvolatile storage medium, and stores a program for implementing each of the above-described functional modules. The storage 193 is configured by, for example, at least one hard disk or a nonvolatile memory. The memory 192 temporarily stores a program loaded from the storage 193, a calculation result by the processor 191, and the like. The memory 192 may be configured by, for example, at least one random access memory. The processor 191 configures each functional module by executing a program in cooperation with the memory 192. The communication port 194 performs data communication with other devices in accordance with a command from the processor 191. For example, the robot controller 10 includes one communication port 194 for transmitting and receiving data signals to and from the camera system 4 and another communication port 194 for transmitting and receiving data signals to and from the motor control device 3.

Each functional module of the robot controller 10 is realized by reading a robot control program on the processor 191 or the memory 192 and causing the processor 191 to execute the program. The robot control program includes codes for implementing the functional modules of the robot controller 10. The processor 191 operates the communication port 194 according to the robot control program, and executes reading and writing of data in the memory 192 or the storage 193.

The robot control program may be provided in a state of being fixedly recorded on a non-transitory recording medium such as a CD-ROM, a DVD-ROM, or a semiconductor memory. Alternatively, the robot control program may be provided as a data signal superimposed on a carrier wave via a communication network.

In one example, the robot control program includes an inference program that realizes at least a function of executing predetermined inference on one or more workpieces 90 shown in the image. The inference program may be provided independently. In one example, the inference system is realized by an inference program.

### System Operation

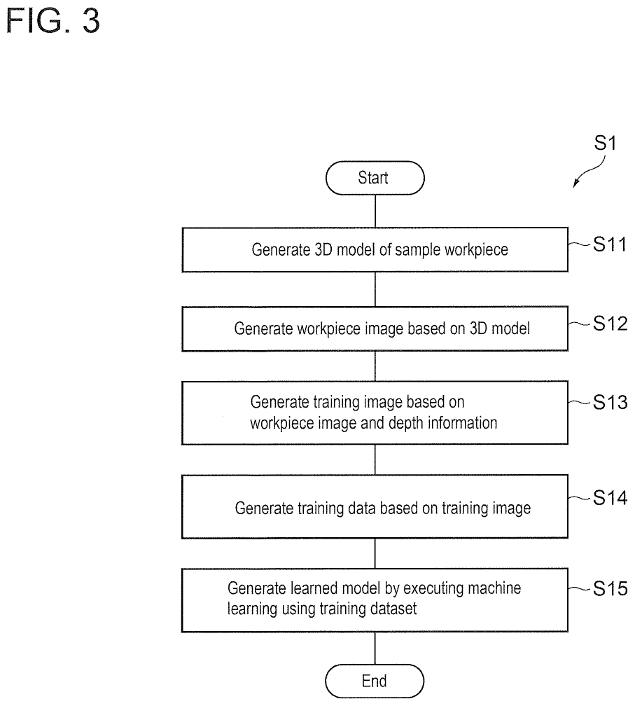

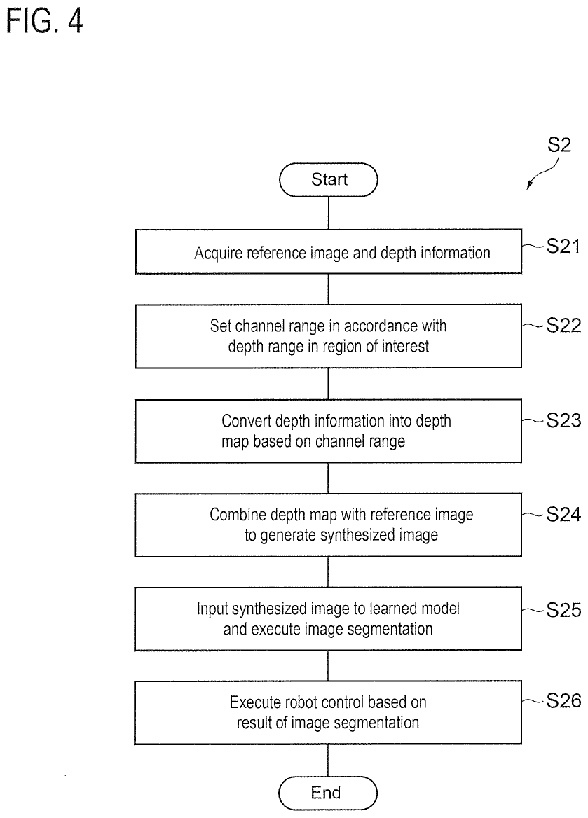

As an example of a robot control method according to the present disclosure, an example of a processing procedure executed by the robot controller 10 will be described with reference to FIGS. 3 and 4. FIG. 3 is a flowchart illustrating an example of processing for generating the learned model 20 as a process flow S1. FIG. 4 is a flowchart illustrating an example of robot control based on inference using the learned model 20 as a process flow S2. That is, the robot controller 10 executes the process flow S1 for generation of the learned model 20, and executes the process flow S2 for robot control based on inference using the learned model 20. From the viewpoint of the learned model 20, the process flow S1 corresponds to a learning phase, and the process flow S2 corresponds to an inference phase (operation phase).

### Generation of Learned Model

An example of processing for generating the learned model 20 will be described with reference to FIG. 3.

In step S11, the training image generation unit 16 generates a 3D model of the sample workpiece. The sample workpiece refers to a workpiece indicated by the training image. For example, the sample workpiece is a workpiece of the same type as the workpiece 90 processed by the robot 2.

The training image generation unit 16 obtains the plurality of captured images by capturing images of the actual sample workpiece from different viewpoints. For example, the training image generation unit 16 may directly receive each captured image from an imaging device such as a camera, may read each captured image from a predetermined storage device such as an image database, or may receive each captured image input by a user.

The training image generation unit 16 generates a 3D model of the sample workpiece from the plurality of acquired captured images. In one example, the training image generation unit 16 estimates, for each of a plurality of captured images of the sample workpiece, the viewpoint of the imaging device (that is, the position and the posture of the imaging device) when the image is captured. For example, the training image generation unit 16 executes the estimation process using a method called COLMAP. The training image generation unit 16 generates a 3D model of the sample workpiece by image synthesis using a neural radiance field (NeRF) based on a plurality of captured images of the sample workpiece. The NeRF represents a scene as a function with a two dimensional vector representing a position in a three dimensional space and a viewpoint direction as an input and a color to be emitted and a density at the position as an output. The NeRF estimates light and transparency (θ, φ) at each position (x, y, z) in a three dimensional space by a neural network. In the case of using NeRF, the training image generation unit 16 inputs each of a plurality of captured images to the neural network based on the viewpoint estimated from the captured image, and estimates a five dimensional (x, y, z, θ, φ) space. Then, the training image generation unit 16 synthesizes the estimation results of the five dimensional space to generate a 3D model configured by a 3D mesh.

In the step S12, the training image generation unit 16 generates one or more workpiece images each indicating a sample workpiece based on the 3D model. Each workpiece image represents a hypothetical sample workpiece obtained by projecting the 3D model by one or more channels that are the same as those of the reference image. In the step S12, the training image generation unit 16 generates one or more workpiece images each indicating a sample workpiece based on the 3D model. In one example, the training image generation unit 16 generates a plurality of workpiece images while changing the viewpoint of the imaginary camera with respect to the 3D model.

As an example different from the steps S11 and S12, the training image generation unit 16 may generate a workpiece image without generating a 3D model. In this modification example, the training image generation unit 16 cuts out a partial region in which the sample workpiece is photographed as a workpiece image from a captured image obtained by capturing an actual sample workpiece. For example, the training image generation unit 16 cuts out one or more workpiece images each indicating a single sample workpiece from a captured image in which one or more sample workpieces are captured.

In step S13, the training image generation unit 16 generates a training image based on one or more workpiece images and the depth information. Typically, the training image generation unit 16 generates a plurality of training images.

In one example, the training image generation unit 16 adjusts one or more channel values of each pixel of each workpiece image so that each of the one or more workpiece images reflects the depth information. For example, the training image generation unit 16 adjusts the workpiece image by combining one or more channel values corresponding to the depth of the pixel with one or more channel values of the pixel for each of a plurality of pixels constituting the workpiece image. The training image generation unit 16 may obtain one or more channel values corresponding to the depth from a user input. Alternatively, the training image generation unit 16 may acquire a depth from a user input and convert the depth into one or more channel values by a predetermined algorithm. In any case, the training image generation unit 16 may perform the synthesis of the channel values in the same manner as the image synthesis unit 12. The depth information is replaced with the channel information and then reflected on the workpiece image. Thus, the adjusted workpiece image is an image that includes channel information and does not include depth information.

The training image generation unit 16 reads a material image indicating an environment corresponding to the target region, for example, a material image indicating the pallet 80 viewed from above, from a predetermined storage device. Then, the training image generation unit 16 pastes one or more adjusted workpiece images (for example, a plurality of adjusted workpiece images) on the material image to generate a training image. The training image is also an image that includes channel information and does not include depth information. The training image generation unit 16 can generate a plurality of training images in which the arrangement of one or more workpieces is different from each other.

In step S14, the training data generation unit 15 generates training data based on the generated training image. The training data generation unit 15 generates a data record of training data by associating a ground truth label indicating a ground truth for image segmentation with each of one or more training images. By this processing, training data including a training image associated with a correct label is obtained. The correct label is set for each sample workpiece. For example, the correct label indicates workpiece information about a sample workpiece in the training image. The workpiece information may include at least one of segmentation of the sample workpiece itself, a position of the sample workpiece, a posture of the sample workpiece, a class indicating a classification of the sample workpiece, and a skeleton of the sample workpiece.

In step S15, the learning unit 17 generates the learned model 20 by executing the machine learning using the training dataset. In one example, the learning unit 17 executes the following processing for each data record of the training data. That is, the learning unit 17 inputs the training image to a predetermined machine learning model. The machine learning model is, for example, a neural network. The learning unit 17 executes backpropagation based on an error between an inference value output from the machine learning model and a correct label associated with the training image, and updates a parameter group in the machine learning model. The learning unit 17 repeats the processing for each data record until a predetermined end condition is satisfied, thereby generating the learned model 20. The termination condition may be to process all data records (training images) of the training data. Alternatively, the termination condition may be that a predetermined index (for example, an error between a correct label and an inference value in evaluation data, a correct answer rate in processing based on evaluation data, or the like) is no longer improved, that is, the index converges.

As described above, the training image does not include depth information. Therefore, the learned model 20 is a calculation model that has been learned to receive an input of an image that does not include depth information and execute predetermined inference. The learned model 20 may also be referred to as a computational model that does not refer to depth information as an independent parameter, but instead considers depth as a result via channel information of the image. It should be noted that the learned model 20 is a calculation model estimated to be optimal, and is not necessarily a “calculation model that is actually optimal”. The learning unit 17 stores the learned model 20 in a predetermined storage device such as the storage 193. The learned model 20 is used by the inference unit 13.

### Robot Control Based on Inference

An example of robot control based on inference using the learned model 20 will be described with reference to FIG. 4.

In step S21, the conversion unit 11 acquires the reference image and the depth information from the camera system 4. In a case where the reference image and the depth image are acquired, the depth information indicates a depth at each of a plurality of depth pixels constituting the depth image. As another example, the conversion unit 11 may acquire an RGB-D image including the reference image and the depth information. In this case, the reference image is an image obtained by channel information of each pixel of the RGB-D image, and the depth information indicates a depth of each pixel of the RGB-D image.

In step S22, the conversion unit 11 sets a channel range defined by a predetermined minimum and a predetermined maximum of one or more channel values in accordance with the depth range in a region of interest. The region of interest refers to a region in which one or more workpieces are present in the target region. The conversion unit 11 processes a part or the whole of the target region as a region of interest. The depth range refers to a range defined by the minimum value and the maximum value of the depth in the region of interest. If the reference image is represented by three channels of R, G, and B, the conversion unit 11 sets a channel range in which the predetermined minimum value is blue (R, G, B)=(0, 0, 255) and the predetermined maximum value is red (255, 0, 0), for example. If the reference image is represented by one channel, the conversion unit 11 sets a channel range in which the predetermined minimum value is 0 and the predetermined maximum value is 255.

In step S23, the conversion unit 11 converts the depth information into a depth map on the basis of the set channel range. As described above, the depth map is represented by channel information corresponding to one or more channels of an image that does not include depth information. The channel information representing the depth map indicates one or more channel values corresponding to one or more channels in each of a plurality of map pixels which are a plurality of pixels constituting the depth map. That is, the depth map represents a depth distribution by a distribution of one or more channel values. As described above, there is a possibility that two or more workpieces 90 among the plurality of workpieces 90 are reflected in the reference image so as to overlap each other, and the depth information can indicate the distribution of the depth in that situation. In this case, two or more workpieces 90 among the plurality of workpieces 90 are also reflected in the depth map so as to overlap each other.

The conversion unit 11 converts the depth of each of the plurality of depth pixels into one or more channel values based on the set channel range. It is assumed that the minimum value and the maximum value of the depth represented by the depth image or the RGB-D image (that is, the minimum value and the maximum value of the depth in the target region) are Dₘᵢₙ and Dₘₐₓ, respectively, and the minimum value and the maximum value of the depth in the region of interest are Di_ₘᵢₙ and Di_ₘₐₓ, respectively. Further, it is assumed that the minimum value and the maximum value of the one or more channel values are Cₘᵢₙ and Cₘₐₓ, respectively. In this case, the channel range {Cₘᵢₙ, Cₘₐₓ} is set in accordance with the depth range {Di_ₘᵢₙ, Di_ₘₐₓ} in the region of interest.

For example, it is assumed that a minimum value Cₘᵢₙ of one or more channel values corresponds to a minimum value Di_ₘᵢₙ of a depth in the region of interest, and a maximum value Cₘₐₓ of one or more channel values corresponds to a maximum value Di_ₘₐₓ of a depth in the region of interest. In this example, when Dₘᵢₙ<Di_ₘᵢₙ<Di_ₘₐₓ<Dₘₐₓ, the conversion unit 11 converts a depth equal to or greater than Dₘᵢₙ and less than Di_ₘᵢₙ into a predetermined fixed color, converts a depth equal to or greater than Di_ₘᵢₙ and equal to or less than Di_ₘₐₓ into one or more channel values within the channel range {Cₘᵢₙ, Cₘₐₓ}, and converts a depth greater than Di_ₘₐₓ and equal to or less than Dₘₐₓ into another predetermined fixed color.

In this way, the conversion unit 11 converts the depth of each of the plurality of depth pixels into one or more channel values in the conversion from the depth information into the depth map. The conversion unit 11 converts the depth of each of the plurality of depth pixels into one or more channel values based on the set channel range.

Typically, the image size of the depth image is smaller than that of the reference image. That is, the plurality of depth pixels constitutes a depth image having an image size smaller than that of the reference image. In this case, the conversion unit 11 executes the blurring process on the initial map to generate a depth map having the same image size as the reference image. For example, the conversion unit 11 executes blurring processing of applying a Gaussian blur to the initial map to generate the depth map.

On the other hand, in a case where the image size is the same between the reference image and the depth image, for example, in a case where an RGB-D image is used, the conversion unit 11 handles the initial map as the depth map as it is.

In step S24, the image synthesis unit 12 combines the depth map with the reference image to generate a synthesized image. The image synthesis unit 12 combines, for each of a plurality of reference pixels that are a plurality of pixels constituting the reference image, one or more channel values of the reference pixel with one or more channel values of a corresponding map pixel, thereby generating a synthesized image. For example, the image synthesis unit 12 may combine the depth map with the reference image by alpha blending in which the coefficient of the reference pixel is larger than the coefficient of the map pixel. The synthesized image is an image that includes channel information and does not include depth information.

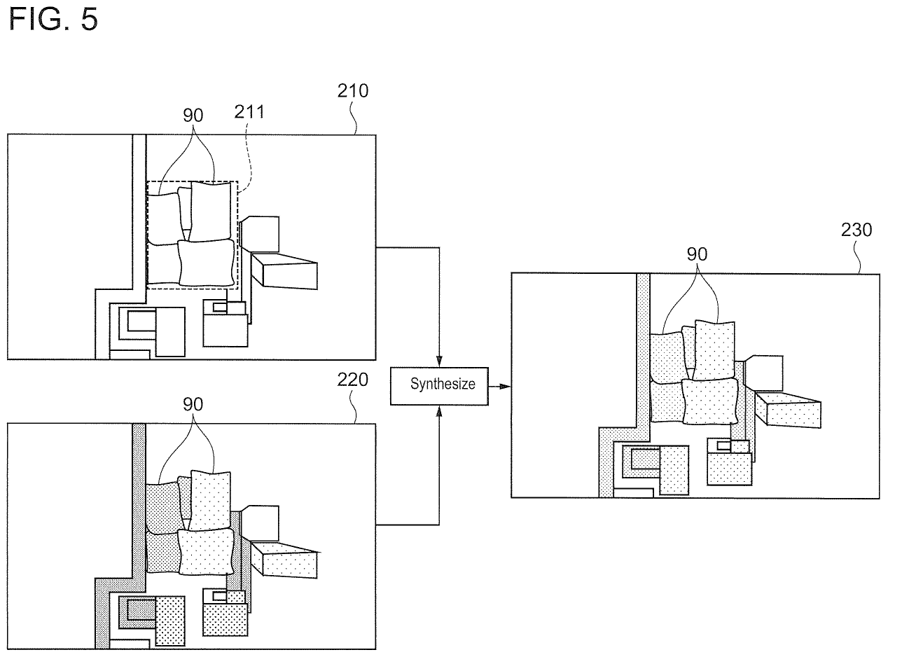

FIG. 5 is a diagram illustrating an example of generation of a synthesized image. The reference image 210 and the depth map 220 in this figure show a plurality of stacked kraft bags as the plurality of workpieces 90. In this example, it is assumed that the conversion unit 11 sets a channel range in accordance with a depth range in a region of interest 211 in which a plurality of workpieces 90 are present in a target region that is a subject range of the reference image 210, and generates a depth map 220 based on the channel range. FIG. 5 schematically illustrates one or more channel values at each pixel of the depth map 220 by hatching. It is assumed that the depth is larger (the distance from the camera system 4 is longer) as the shading is darker. The image synthesis unit 12 combines the depth map 220 with the reference image 210 to generate a synthesized image 230. The shading in the synthesized image 230 schematically indicates the result of synthesizing one or more channel values between the reference image 210 and the depth map 220 by a method such as alpha blending. Since the one or more channel values at each pixel of the synthesized image 230 reflect depth, the synthesized image 230 more clearly represents the boundary of the workpiece 90, which may be difficult to distinguish using only the reference image 210, in a clearer manner. For example, the synthesized image 230 may clearly represent the boundary between the workpiece 90 in the upper stage and the workpiece 90 in the lower stage, which may not be distinguished only by the reference image 210.

Returning to FIG. 4, in step S25, the inference unit 13 inputs the synthesized image to the learned model 20 and executes image segmentation on one or more workpieces 90 shown in the reference image. The learned model 20 performs image segmentation on the input synthesized image, and outputs an instance of each of one or more workpieces 90 as a result of inference. As a result, the inference unit 13 generates instances of the above.

In step S26, the robot control unit 14 executes robot control based on the result of the image segmentation. The robot control unit 14 causes the robot 2 to execute processing of taking out at least one of the one or more workpieces 90 from the pallet 80 based on the instance of each of the one or more workpieces 90. In one example, the robot control unit 14 selects one workpiece that can be taken out from the one or more workpieces 90 (for example, the workpiece 90 located at the uppermost position among the plurality of workpieces 90). Then, the robot control unit 14 generates a path for taking out the selected workpiece 90 and placing the workpiece 90 in a predetermined placement location. The path indicates a trajectory of the robot 2, for example, a trajectory of the end effector 2a. In one example, the robot control unit 14 generates a path so that the robot 2 does not interfere with an obstacle. Interference refers to a phenomenon in which an object contacts or collides with another object. It should be noted that, when the robot 2 is to process a certain workpiece 90, contact between the robot 2 and the workpiece 90 is not interference. The robot control unit 14 generates a series of control signals indicating the generated path as a command, and sequentially outputs the control signals to the motor control device 3. The motor control device 3 sequentially generates electric power for driving the motor based on the control signal, and sequentially supplies the electric power to the motor. As a result, the robot 2 takes out the selected workpiece 90 from the pallet 80 and places the workpiece 90 in a predetermined place.

The robot system 1 (robot controller 10) can repeatedly execute the process flow S2. For example, the robot system 1 (the robot controller 10) repeatedly executes the process flow S2 until all of the plurality of workpieces 90 are taken out from the pallet 80.

### Modifications

The technology according to the present disclosure has been described above in detail based on various examples thereof. However, the present disclosure is not limited to the above examples. The technology according to the present disclosure can be modified in various ways without departing from the gist thereof.

Although the inference unit 13 performs image segmentation in the above example, the inference unit 13 may perform another type of inference. For example, the inference unit 13 may execute another inference such as classification.

In the above example, the robot control unit 14 executes the picking process as the process related to one or more workpieces. However, the robot control unit 14 may cause the robot to execute other processing regardless of whether or not the predetermined inference is image segmentation. For example, the robot control unit 14 may cause the robot to execute an operation of sorting the plurality of workpieces into two or more groups.

The robot control system may use a learned model generated by another computer. Therefore, the robot control system may not include functional modules corresponding to the training data generation unit 15, the training image generation unit 16, and the learning unit 17. That is, the robot control system may not execute the process flow S1.

An inference system may be provided that does not include a functional module corresponding to the robot control unit 14 and includes functional modules corresponding to the conversion unit 11, the image synthesis unit 12, and the inference unit 13. The conversion unit 11 converts the depth information about the target region including one or more workpieces into a depth map represented by channel information corresponding to one or more channels of an image not including the depth information. The image synthesis unit 12 generates a synthesized image by combining the depth map with a reference image in which the target region is captured. The inference unit 13 inputs the synthesized image to a learned model that has been learned to receive an input of an image not including depth information and execute predetermined inference, and executes the predetermined inference on one or more workpieces. The inference unit 13 outputs the result of inference. The inference result may be used to cause the robot to process a workpiece, may be used to notify a user of a specific workpiece (for example, a workpiece having an abnormality, a defect, or the like), or may be used for another purpose. The inference system according to this modification is implemented by causing a processor or a memory to read an inference program including codes for implementing the conversion unit 11, the image synthesis unit 12, and the inference unit 13 and causing the processor to execute the inference program. An inference method according to an example is realized by the inference system. The inference system according to this modification may further include functional modules corresponding to the training data generation unit 15, the training image generation unit 16, and the learning unit 17.

An image generation system may be provided that does not include functional modules corresponding to the inference unit 13, the robot control unit 14, the training data generation unit 15, the training image generation unit 16, and the learning unit 17, but includes functional modules corresponding to the conversion unit 11 and the image synthesis unit 12. The conversion unit 11 converts the depth information about the target region including one or more workpieces into a depth map represented by channel information corresponding to one or more channels of an image not including the depth information. The image synthesis unit 12 generates a synthesized image by combining the depth map with a reference image in which the target region is captured. The image synthesis unit outputs the generated synthesized image. The synthesized image can be used by another computer system for various purposes such as generation of a learned model, predetermined inference, and predetermined image processing. The image generation system according to this modification is implemented by causing a processor or a memory to read an image generation program including codes for implementing the conversion unit 11 and the image synthesis unit 12 and causing the processor to execute the image generation program. An image generation method according to an example is realized by the image generation system.

An inference system may be provided that does not include functional modules corresponding to the conversion unit 11, the image synthesis unit 12, the robot control unit 14, the training data generation unit 15, and the training image generation unit 16, and includes functional modules corresponding to the learning unit 17 and the inference unit 13.

The learning unit 17 executes machine learning using training data including a training image associated with a correct label for predetermined inference. By this machine learning, the learning unit 17 generates a learned model that receives an input of an image not including depth information and executes predetermined inference. In this modification, the learning unit 17 acquires a training image generated by another computer system. As described above, the training image is an image obtained by combining, for each of a plurality of pixels constituting a workpiece image representing a sample workpiece by one or more channels, one or more channel values corresponding to a depth at the pixel with one or more channel values of the pixel. That is, the training image is an image obtained by adjusting one or more channel values of each pixel of the workpiece image so that the workpiece image reflects the depth information.

The inference unit 13 inputs the synthesized image to the generated learned model and executes predetermined inference. In this modification, the inference unit 13 acquires a synthesized image generated by another computer system. As described above, the synthesized image is an image generated by combining a depth map, which expresses depth information about a target region including one or more workpieces by channel information corresponding to one or more channels, with a reference image capturing the target region. The inference unit 13 inputs the synthesized image to the learned model and executes predetermined inference on one or more workpieces. The inference unit 13 outputs the result of inference. The inference result may be used to cause the robot to process a workpiece, may be used to notify a user of a specific workpiece (for example, a workpiece having an abnormality, a defect, or the like), or may be used for another purpose.

The inference system according to this modification is implemented by causing a processor or a memory to read an inference program including codes for implementing the learning unit 17 and the inference unit 13 and causing the processor to execute the inference program. An inference method according to an example is realized by the inference system.

The hardware configuration of the system is not limited to the mode in which each functional module is realized by executing a program. For example, at least a part of the functional module group described above may be configured by a logic circuit specialized for the function, or may be configured by an application specific integrated circuit (ASIC) in which the logic circuit is integrated.

The processing procedure of the method executed by the at least one processor is not limited to the above example. For example, some of the steps or processes described above may be omitted, or the steps may be executed in a different order. In addition, any two or more steps among the above-described steps may be combined, or some of the steps may be modified or deleted. Alternatively, other steps may be performed in addition to the steps described above.

When comparing the magnitude relationship between two numerical values in a computer system or a computer, either of two criteria of “equal to or greater than” and “greater than” may be used, and either of two criteria of “equal to or less than” and “less than” may be used.

### Supplementary Note

As can be understood from the various examples described above, the present disclosure includes the following aspects.

### Supplementary Note 1

A robot control system includes a conversion unit configured to convert depth information about a target region including one or more workpieces into a depth map represented by channel information corresponding to one or more channels of an image that does not include the depth information, an image synthesis unit configured to generate a synthesized image by combining the depth map with a reference image capturing the target region, an inference unit configured to input the synthesized image to a learned model that has been learned to receive an input of the image that does not include the depth information and to execute predetermined inference, and execute the predetermined inference on the one or more workpieces; and a robot control unit configured to cause a robot present in a real work space to execute processing related to the one or more workpieces based on a result of the predetermined inference for the one or more workpieces.

According to supplementary note 1, the depth information on one or more workpieces is converted into the depth map represented by the channel information and then reflected on the reference image. Then, inference by the learned model is executed for the synthesized image in which the three dimensional position is reflected by the channel information, and processing related to the workpiece is executed by the robot based on the inference result. The synthesized image more clearly represents the boundary of the workpiece that may be difficult to distinguish only with the reference image. For example, the synthesized image may clearly represent the boundary between the upper workpiece and the lower workpiece that may not be distinguished by the reference image alone. By performing inference on such a synthesized image, it is possible to cause the robot to accurately process the workpiece. In addition, since the depth information is converted into information (channel information) at the same level as that of the reference image and reflected in the synthesized image, it is possible to control the robot using a general learned model without preparing a learned model that refers to the depth information as an independent parameter.

### Supplementary Note 2

The robot control system according to supplementary note 1, wherein the learned model executes, as the predetermined inference, image segmentation that is processing of identifying the workpiece from the image that does not include the depth information, wherein the inference unit inputs the synthesized image to the learned model to generate an instance for each of the one or more workpieces, and wherein the robot control unit controls the robot to execute the processing related to the one or more workpieces based on the instance of each of the one or more workpieces.

According to supplementary note 2, the synthetic image reflecting the depth information converted into the depth map (channel information) is input to the learned model, and the instance of each workpiece is generated. Then, based on the instance, the processing related to the workpiece is executed by the robot. By this series of processing, it is possible to accurately specify each workpiece and cause the robot to accurately process the workpiece. In addition, it is possible to perform image segmentation and robot control using a general learned model without preparing a learned model that refers to depth information as an independent parameter.

### Supplementary Note 3

The robot control system according to supplementary note 2, wherein the one or more workpieces are a plurality of workpieces, wherein, in the reference image and the depth map, two or more workpieces among the plurality of workpieces appear so as to overlap with each other, and wherein the inference unit inputs the synthesized image to the learned model to generate an instance for each of the plurality of workpieces.

According to supplementary note 3, it is possible to accurately specify each of two or more workpieces that are shown in an image to overlap each other and cause a robot to accurately process each workpiece.

### Supplementary Note 4

The robot control system according to supplementary note 3, wherein the target region includes a region in which the plurality of workpieces are stacked on a pallet, the depth direction indicated by the depth information is a direction in which the plurality of workpieces are stacked, and the robot control unit causes the robot to execute a process of taking out at least one of the plurality of workpieces from the pallet as the process related to the one or more workpieces.

According to supplementary note 4, the boundary of each of the overlapped workpieces, which may be difficult to be distinguished only by the reference image, is clearly represented by the synthesized image. The inference performed on this composite image enables the robot to accurately execute the retrieval of the workpiece.

### Supplementary Note 5

The robot control system according to any one of supplementary notes 1 to 4, wherein the depth information indicates a depth of each of a plurality of depth pixels that are a plurality of pixels indicating the target region, the channel information indicates one or more channel values corresponding to the one or more channels of each of a plurality of map pixels that are a plurality of pixels constituting the depth map, the conversion unit converts the depth at each of the plurality of depth pixels into the one or more channel values in the conversion into the depth map, and the image synthesis unit synthesizes, for each of a plurality of reference pixels that are a plurality of pixels constituting the reference image, one or more channel values of the reference pixel with the one or more channel values of the corresponding map pixel, thereby generating the synthesized image.

According to supplementary note 5, since the depth information is reflected in each pixel of the reference image, a synthesized image showing the position of each workpiece in the three dimensional space in detail in pixel units is obtained. By using the synthesized image, it is possible to accurately execute inference regarding the workpiece and cause the robot to accurately execute processing regarding the workpiece.

### Supplementary Note 6)

The robot control system according to supplementary note 5, wherein the conversion unit is configured to set a channel range defined by a predetermined minimum value and a predetermined maximum value of the one or more channel values in accordance with a depth range defined by a minimum value and a maximum value of the depths in a region of interest within the target region in which the one or more workpieces are present, and to convert the depth at each of the plurality of depth pixels into the one or more channel values based on the set channel range.

According to supplementary note 6, the depth at each pixel is converted into one or more channel values based on the channel range set so as to correspond to the depth range in the region of interest where the workpiece is present. By this processing, the position of each workpiece in the three dimensional space is reflected in the depth map in more detail without depending on the depth around the region of region of interest (that is, the depth in the region where no workpiece exists). As a result, the position of each workpiece in the three dimensional space is finally reflected in the synthesized image in more detail. By using the synthesized image, it is possible to more accurately execute inference regarding the workpiece and cause the robot to more accurately execute processing regarding the workpiece.

### Supplementary Note 7

The robot control system according to supplementary note 5 or 6, wherein the image synthesis unit synthesizes the depth map with the reference image by alpha blending in which the coefficient of the reference pixel is larger than the coefficient of the map pixel. According to supplementary note 7, since the reference image having a larger amount of information than the depth map is reflected in the synthesized image in a larger manner, it is possible to generate a synthesized image in which the reference image and the depth information are balanced. For example, a synthesized image that enables more accurate identification of a workpiece can be generated by further using depth information while maintaining information for identifying individual workpieces, such as edges of workpieces. By using such a synthesized image, it is possible to more accurately execute inference regarding the workpiece and cause the robot to more accurately execute processing regarding the workpiece.

### Supplementary Note 8

The robot control system according to any one of supplementary notes 5 to 7, wherein the plurality of depth pixels may constitute a depth image having an image size smaller than that of the reference image, and the conversion unit performs a blurring process on an initial map constituted by the converted one or more channel values for each of the plurality of depth pixels to generate the depth map having the same image size as the reference image. According to supplementary note 8, even when the depth image indicating the depth information is smaller than the reference image, the depth map having the same image size as the reference image is obtained by the blurring process, and thus the depth map can be easily associated with the reference image. That is, the synthesized image can be easily generated by absorbing the difference in image size between the reference image and the depth image.

### Supplementary Note 9

The robot control system according to any one of supplementary notes 1 to 8, further including a training image generation unit configured to generate a training image by, for each of a plurality of pixels constituting a workpiece image representing a sample workpiece by the one or more channels, combining, with one or more channel values of the pixel, one or more channel values corresponding to a depth at the pixel; and a learning unit configured to generate the learned model by executing machine learning using training data including the training image associated with a correct label for the predetermined inference.

According to supplementary note 9, the training image used in the machine learning for generating the learned model is generated in a form in which the depth is reflected as one or more channel values. Using this training image, a learned model can be generated that takes into account depth via one or more channel values rather than referencing depth information as an independent parameter. Further, by using a training image prepared by a method similar to that for a synthesized image to be inferred, it is possible to generate a learned model capable of accurately executing predetermined inference on the synthesized image. That is, the learned model can be caused to function more accurately.

### Supplementary Note 10

The robot control system according to supplementary note 9, wherein the training image generation unit is configured to generate a 3D model of the sample workpiece from a plurality of captured images obtained by capturing an actual sample workpiece from different viewpoints, generate one or more workpiece images each of which shows the sample workpiece, based on the 3D model, and generate the training image by using the one or more workpiece images.

According to supplementary note 10, the 3D model of the sample workpiece is generated from the plurality of different captured images, and the training image is generated using the workpiece image based on the 3D model. By such a series of processes, it is possible to easily generate a training image similar to a real situation without preparing individual training images by imaging. The training data can be prepared more easily by that amount.

### Supplementary Note 11

The robot control system according to supplementary note 9, wherein the training image generation unit is configured to cut out a partial region in which the sample workpiece is imaged as the workpiece image from a captured image obtained by capturing an actual sample workpiece, and generate the training image by using one or more of the workpiece images.

According to supplementary note 11, it is possible to generate a training image by using or reusing an existing captured image. That is, training data can be prepared using existing data resources.

### Supplementary Note 12

An inference system including a conversion unit configured to convert depth information about a target region including one or more workpieces into a depth map represented by channel information corresponding to one or more channels of an image not including the depth information, an image synthesis unit configured to synthesize the depth map with a reference image in which the target region is captured to generate a synthesized image, and an inference unit configured to input the synthesized image to a learned model that has been learned to receive an input of the image that does not include the depth information and execute predetermined inference, and execute the predetermined inference on the one or more workpieces.

According to supplementary note 12, the depth information on one or more workpieces is converted into the depth map represented by the channel information and then reflected on the reference image. Then, inference by the learned model is executed for the synthesized image in which the three dimensional position is reflected by the channel information, and processing related to the workpiece is executed by the robot based on the inference result. The synthesized image more clearly represents the boundary of the workpiece that may be difficult to distinguish only with the reference image. For example, the synthesized image may clearly represent the boundary between the upper workpiece and the lower workpiece that may not be distinguished by the reference image alone. By using the synthesized image, the workpiece reflected in the image can be accurately inferred. In addition, in the synthesized image, the depth information is converted into information (channel information) at the same level as that of the reference image and then reflected, and thus it is possible to perform inference using a general learned model without preparing a learned model that refers to the depth information as an independent parameter. Based on the inference result obtained by such a mechanism, for example, it is possible to cause the robot to accurately process the workpiece.

### Supplementary Note 13

A robot control method, executed by a robot control system including at least one processor, including converting depth information about a target region including one or more workpieces into a depth map represented by channel information corresponding to one or more channels of an image not including the depth information, generating a synthesized image by combining the depth map with a reference image that shows the target region, inputting the synthesized image to a learned model that has been learned to receive an input of the image that does not include the depth information and to execute predetermined inference, and executing the predetermined inference on the one or more workpieces; and causing a robot present in a real work space to execute processing related to the one or more workpieces based on a result of the predetermined inference for the one or more workpieces. According to supplementary note 13, the same technical effect as that of supplementary note 1 can be obtained.

### Supplementary Note 14

A robot control program including converting depth information about a target region including one or more workpieces into a depth map represented by channel information corresponding to one or more channels of an image that does not include the depth information, generating a synthesized image by combining the depth map with a reference image that shows the target region, inputting the synthesized image to a learned model that has been learned to receive an input of the image that does not include the depth information and to execute predetermined inference, and executing the predetermined inference on the one or more workpieces, and causing a robot present in a real work space to execute processing related to the one or more workpieces based on a result of the predetermined inference on the one or more workpieces.

According to supplementary note 14, the same technical effect as that of supplementary note 1 can be obtained.

### Supplementary Note 15

An image generation method, executed by an image generation system including at least one processor, including converting depth information about a target region including one or more workpieces into a depth map represented by channel information corresponding to one or more channels of an image not including the depth information, and generating a synthesized image by combining the depth map with a reference image that shows the target region.

According to supplementary note 15, the depth information on one or more workpieces is converted into the depth map represented by the channel information and then reflected in the reference image. The synthesized image more clearly represents the boundary of the workpiece that may be difficult to distinguish only with the reference image. For example, the synthesized image may clearly represent the boundary between the upper workpiece and the lower workpiece that may not be distinguished by the reference image alone. In one example, the workpiece shown in the image can be accurately inferred by using the synthesized image. In addition, in the synthesized image, the depth information is converted into information (channel information) of the same level as that of the reference image and then reflected. Therefore, in one example, it is possible to perform inference using a general learned model without preparing a learned model that refers to depth information as an independent parameter. As a further example, based on the inference result obtained by such a mechanism, for example, it is possible to cause the robot to accurately process the workpiece.

### Supplementary Note 16

An inference system including a learning unit that executes machine learning by using training data that includes a training image associated with a correct label for predetermined inference, and generates a learned model that receives an input of an image that does not includes depth information and executes the predetermined inference, the training image being generated by combining, for each of a plurality of pixels constituting a workpiece image representing a sample workpiece by one or more channels, one or more channel values corresponding to a depth at the pixel with one or more channel values of the pixel; and an inference unit configured to input a synthesized image generated by combining a depth map that expresses depth information about a target region including one or more workpieces by channel information corresponding to the one or more channels, with a reference image capturing the target region, to the learned model, and execute the predetermined inference on the one or more workpieces.

According to supplementary note 16, machine learning is executed using a training image generated in a form in which a depth is reflected as one or more channel values, and a learned model is generated. Then, inference by the learned model is executed for the synthesized image in which the depth information about one or more workpieces is reflected by the channel information. With this mechanism, it is possible to accurately infer a workpiece captured in an image using a learned model that considers depth via one or more channel values, rather than referring to depth information as an independent parameter. Based on the inference result, for example, it is possible to cause the robot to accurately process the workpiece.

The present invention is not limited to the above-described embodiments or modifications, and it is apparent that the embodiments or modifications can be appropriately modified or changed within the scope of the technical idea of the present invention. In addition, various techniques used in each embodiment or each modifications are applicable to other embodiments or other modifications as long as a technical contradiction does not occur. Further, any additional configuration in each embodiment or each modification can be omitted as appropriate.

What is claimed is:

1. A robot control system comprising:
a converter configured to convert depth information with respect to a target region including one or more workpieces into a depth map represented by channel information corresponding to one or more channels of an image that does not include the depth information;
an image synthesizer configured to synthesize the depth map with a reference image capturing the target region to generate a synthesized image;
inference circuitry configured to input the synthesized image to a learned model that has learned to execute a predetermined inference by receiving the image that does not include the depth information so that the inference circuitry executes the predetermined inference on the one or more workpieces; and
robot control circuitry configured to control a robot that exists in a real work space to execute processing related to the one or more workpieces based on a result of the predetermined inference for the one or more workpieces.

2. The robot control system according to claim 1,
wherein the learned model is configured to execute, as the predetermined inference, image segmentation in which the one or more workpieces are identified from the image that does not include the depth information,
wherein the inference circuitry is configured to input the synthesized image to the learned model to generate an instance for each of the one or more workpieces, and
wherein the robot control circuitry is configured to control the robot to execute the processing related to the one or more workpieces based on the instance of each of the one or more workpieces.

3. The robot control system according to claim 2,
wherein the one or more workpieces include a plurality of workpieces,
wherein two or more workpieces among the plurality of workpieces in the reference image and the depth map overlap with each other, and
wherein the inference circuitry is configured to input the synthesized image to the learned model to generate an instance for each of the plurality of workpieces.

4. The robot control system according to claim 3,
wherein the target region includes a region in which the plurality of workpieces are stacked on a pallet,
wherein the depth direction indicated by the depth information is a direction in which the plurality of workpieces are stacked, and
wherein the robot control circuitry is configured to control the robot to execute a process of taking out at least one of the plurality of workpieces from the pallet as the process related to the one or more workpieces.

5. The robot control system according to claim 1,
wherein the depth information indicates a depth of each of a plurality of depth pixels that are a plurality of pixels indicating the target region,
wherein the channel information indicates one or more channel values corresponding to the one or more channels of each of a plurality of map pixels that are a plurality of pixels constituting the depth map,
wherein, in the conversion into the depth map, the converter is configured to convert the depth at each of the plurality of depth pixels into the one or more channel values, and
wherein the image synthesizer is configured to synthesize, for each of a plurality of reference pixels that are a plurality of pixels constituting the reference image, one or more channel values of the reference pixel with the one or more channel values of the corresponding map pixel so as to generate the synthesized image.

6. The robot control system according to claim 5,
wherein the converter is configured to
set a channel range defined by a predetermined minimum value and a predetermined maximum value of the one or more channel values in accordance with a depth range defined by a minimum value and a maximum value of the depths in a region of interest within the target region in which the one or more workpieces exist, and
convert the depth at each of the plurality of depth pixels into the one or more channel values based on the set channel range.

7. The robot control system according to claim 5,
wherein the image synthesizer synthesizes the depth map with the reference image by alpha blending in which the coefficient of the reference pixel is larger than the coefficient of the map pixel.

8. The robot control system according to claim 5,
wherein the plurality of depth pixels constitute a depth image having an image size smaller than a reference image size of the reference image, and
wherein the converter is configured to perform a blurring process on an initial map constituted by the converted one or more channel values for each of the plurality of depth pixels to generate the depth map such that the image size is same as the reference image size.

9. The robot control system according to claim 1, further comprising:
a training image generator configured to generate a training image by, for each of a plurality of pixels constituting a workpiece image representing a sample workpiece by the one or more channels, combining one or more channel values corresponding to a depth at the pixel with one or more channel values of the pixel; and
learning circuitry configured to generate the learned model by executing machine learning using training data including the training image associated with a correct label for the predetermined inference.

10. The robot control system according to claim 9,
wherein the training image generator is configured to
generate a 3D model of the sample workpiece from a plurality of captured images obtained by capturing an actual sample workpiece from different viewpoint;
generate one or more workpiece images each of which shows the sample workpiece based on the 3D model; and
generate the training image by using the one or more workpiece images.

11. The robot control system according to claim 9,
wherein the training image generator is configured to
cut out a partial region in which the sample workpiece is imaged as the workpiece image from a captured image obtained by capturing an actual sample workpiece, and
generate the training image by using one or more of the workpiece images.

12. An inference system comprising:
a converter configured to convert depth information with respect to a target region including one or more workpieces into a depth map represented by channel information corresponding to one or more channels of an image that does not include the depth information;
an image synthesizer configured to synthesize the depth map with a reference image capturing the target region to generate a synthesized image; and
inference circuitry configured to input the synthesized image to a learned model that has learned to execute a predetermined inference by receiving the image that does not include the depth information so that the inference circuitry executes the predetermined inference on the one or more workpieces.

13. A robot control method, executed by a robot control system including at least one processor, comprising:
converting depth information with respect to a target region including one or more workpieces into a depth map represented by channel information corresponding to one or more channels of an image that does not include the depth information;
synthesizing the depth map with a reference image that captures the target region to generate a synthesized image;
inputting the synthesized image to a learned model that has learned to execute a predetermined inference by receiving the image that does not include the depth information so as to execute the predetermined inference on the one or more workpieces; and
controlling a robot that exists in a real work space to execute processing related to the one or more workpieces based on a result of the predetermined inference for the one or more workpieces.
